(19) United States
(12) Patent Application Publication
(10) Pub. No.: US 2023/0102702 A1
(43) Pub. Date: Mar. 30, 2023

(54) METHOD AND DEVICE FOR IMPROVING FACIAL IMAGE

(71) Applicant: PIXTREE CO., LTD., Seoul (KR)

(72) Inventors: Jaeseob SHIN, Seoul (KR); Sungul RYOO, Seoul (KR); Sehoon SON, Seoul (KR); Hyeongduck KIM, Gyeonggi-do (KR); Hyosong KIM, Seoul (KR); Kyunghwan KO, Seoul (KR)

(21) Appl. No.: 18/075,400

(22) Filed: Dec. 5, 2022

Related U.S. Application Data
(63) Continuation-in-part of application No. PCT/KR2021/007012, filed on Jun. 4, 2021.

(30) Foreign Application Priority Data
Jun. 5, 2020 (KR) 10-2020-0068165

(51) Int. Cl. G06T 5/00; G06T 3/00; G06T 3/60; G06T 7/70; G06V 40/16; G06V 10/22

(52) U.S. Cl. CPC G06T 5/001; G06T 3/0093; G06T 3/60; G06T 7/70; G06V 40/161; G06V 10/225; G06T 2207/30201

(57) ABSTRACT

Provided are a method and a device for restoring a facial image, capable of restoring an image naturally by detecting positions of landmarks of a face in a bounding-box detected from an input image, improving an image using a learning model learned from a front facial image after performing warping for aligning a front face to be positioned at a central position or a reference position on the basis of the landmarks, performing inverse warping for rotating the improved image in an original direction or at an original angle, and inserting the inversely-warped image into the input image. In addition, provided are a method and a device for restoring a facial image, capable of performing pose estimation for a face in a bounding-box detected from an input image, and improving the image using a learning model learned from a side facial image corresponding to a result of the pose estimation.

### TECHNICAL FIELD

An embodiment of the present disclosure relates to a method and a device for restoring a facial image.

### BACKGROUND ART

The contents described herein merely provide background information related to the present inventive concept, and do not constitute the prior art.

In general, techniques for restoring a low-resolution image to a high-resolution image are classified according to the number of input images used for restoration or restoring techniques. The techniques are classified into a single image super-resolution restoring technique and a continuous image super-resolution restoring technique, according to the number of input images.

Generally, the single image super-resolution image restoring technique has a faster processing speed than that of the continuous image super-resolution image restoring technique, but has a low quality of image restoration since information necessary for restoration is insufficient.

Since the continuous image super-resolution image restoring technique uses various features extracted from a plurality of consecutively acquired images, the quality of the restored image is superior to that of the single image super-resolution image restoring technique, but its algorithm is complicated and the amount of computation is large, thereby making it difficult to perform real-time processing.

As the restoring techniques, a technique using interpolation, a technique using edge information, a technique using frequency characteristics, or a technique using machine learning such as deep learning is used. The technique using learning such as deep learning is used. The technique using interpolation has a high processing speed, but has a disadvantage of blurring of edge parts.

The technique using edge information has a high processing speed and maintains the sharpness of edge parts, but has a disadvantage of a visually noticeable restoration error in a case where an edge direction is incorrectly estimated.

The technique using frequency characteristics maintains the sharpness of edge parts using high-frequency components similar to the technique using edge information, but has a disadvantage of occurrence of a ringing artifact near a boundary. Finally, the technique using machine learning such as example-based explanation or deep learning has the highest quality of restored images, but its processing speed is very slow.

As described above, among the various high-resolution image restoring techniques, the continuous image super-resolution image restoring technique may be applied to fields necessary for a digital zoom function using the existing interpolation method, and can provide images of superior quality compared to the interpolation-based image restoring technique. However, the existing super-resolution image restoring technique is limited in its application to electro-optical equipment that requires limited resources and real-time processing due to a large amount of computation.

The existing single image-based super-resolution image restoring technique capable of real-time processing has a problem in that performance is significantly reduced compared to the continuous image-based restoring technique in a case where an image needs to be enlarged with a high magnification of 2 times or more.

### DISCLOSURE

### Technical Problem

An object of the present inventive concept is to provide a method and a device for restoring a facial image by detecting positions of landmarks of a face in a bounding-box detected from an input image, improving an image using a learning model learned from a front facial image after performing warping for aligning a front face to be positioned at a central position on the basis of the landmarks, performing inverse warping for rotating the improved image in an original direction or at an original angle, and inserting the inversely-warped image into the input image to restore a natural image.

In addition, another object of the present inventive concept is to provide a method and a device for restoring a facial image by performing pose estimation for a face in a bounding-box detected from an input image, and improving the image using a learning model learned from a side facial image corresponding to a result of the pose estimation.

### Technical Solution

According to an aspect of the present inventive concept, there is provided a device for improving a facial image including: a bounding-box detecting section that detects a bounding-box from an input image; a landmark detecting section that detects landmarks that are main features of a face in the bounding-box; a warping section that performs warping for aligning a face position at a central position or a reference position on the basis of the landmarks to generate a warped facial image; an inference section that performs inference so as to improve the warped facial image using a pre-learned leaning model to generate an improved facial image; an inverse warping section that performs inverse warping for inverting the improved facial image to the face position of the input image to generate an inversely-warped facial image; and an output section that applies the inversely-warped facial image to the input image.

According to another aspect of the present inventive concept, there is provided a facial image improving method including: detecting a bounding-box from an input image; detecting landmarks that are main features of a face in the bounding-box; performing warping for aligning a face position at a central position or a reference position on the basis of the landmarks to generate a warped facial image; performing inference so as to improve the warped facial image using a pre-learned leaning model to generate an improved facial image; performing inverse warping for inverting the improved facial image to the face position of the input image to generate an inversely-warped facial image; and applying the inversely-warped facial image to the input image.

According to still another aspect of the present inventive concept, there is provided a device for improving a facial image, including: a bounding-box detecting section that detects a bounding-box from an input image; a pose estimating section that calculates a facial angle in the bounding-box; a parameter selecting section that selects a parameter corresponding to the facial angle; and an inference section that performs inference so as to improve the facial image using a pre-learned leaning model to generate an improved facial image.

According to yet still another aspect of the present inventive concept, there is provided a method for improving a facial image, including: detecting a bounding-box from an input image; calculating a facial angle in the bounding-box; selecting a parameter corresponding to the facial angle; and performing inference so as to improve the facial image in the bounding-box using a learning model corresponding to the parameter to generate an improved facial image.

### Advantageous Effects

As described above, according to the present inventive concept, it is possible to detect positions of landmarks of a face in a bounding-box detected from an input image, perform warping for aligning a front face to be positioned at a central position on the basis of the landmarks, improve the aligned image using a learning model learned from a front facial image, perform inverse warping for rotating the improved image to an original direction or at an original angle, and insert the inversely-warped image into the input image to restore a natural image.

According to the present embodiment, it is possible to detect positions of landmarks of a face in a bounding-box detected from an input image, perform pose estimation for a side face on the basis of the landmarks, and improve an image using a learning model learned from a side facial image corresponding to a pose estimation result.

### DESCRIPTION OF DRAWINGS

FIGS. 1A and 1B are diagrams illustrating an image restoring device according to an exemplary embodiment of the invention.

FIG. 2 is a diagram illustrating a facial image improving process according to an exemplary embodiment of the invention.

FIG. 3 is a diagram illustrating bounding-box detection and landmark position detection according to an exemplary embodiment of the invention.

FIG. 4 is a diagram illustrating a facial image warping process according to an exemplary embodiment of the invention.

FIG. 5 is a diagram illustrating the warping process according to the exemplary embodiment in detail.

FIG. 6 is a diagram illustrating warping of a plurality of images according to an exemplary embodiment of the invention.

FIG. 7 is a diagram illustrating face pose estimation according to an exemplary embodiment of the invention.

### DESCRIPTION OF REFERENCE NUMERALS

100: Facial image improving device
110: Input section
120: Bounding-box detecting section
130: Landmark detecting section
140: Warping section
150: Pose estimating section
152: Parameter selecting section
160: Resizing section
170: Inference section
172: Learning section
180: Inversely-resizing section
190: Inverse warping section
192: Output section

### DETAILED DESCRIPTION

Hereinafter, exemplary embodiments of the invention will be described in detail with reference to the accompanying drawings.

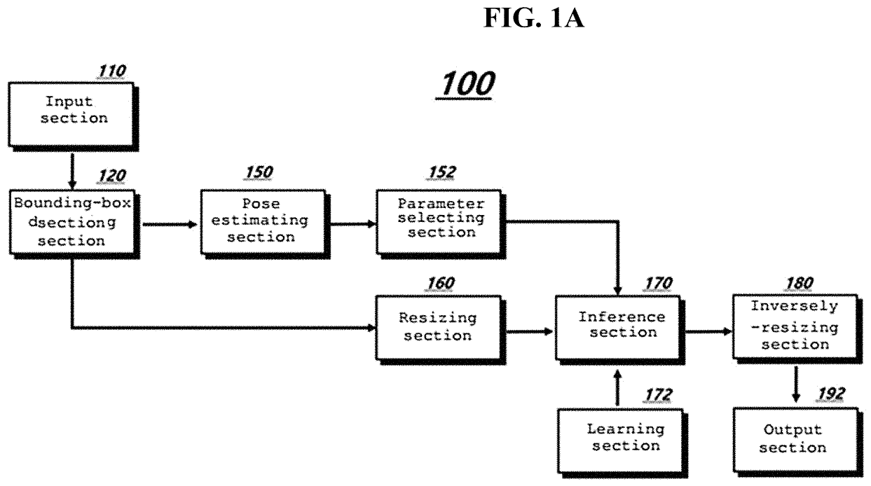

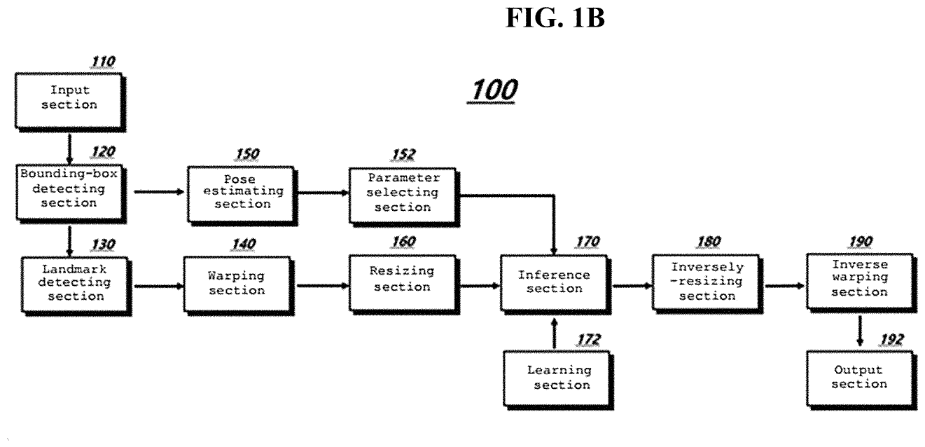

FIGS. 1A and 1B are diagrams illustrating an image restoring device according to an exemplary embodiment of the invention.

A facial image improving device 100 detects an area where a face is located from an input image using a bounding-box. The facial image improving device 100 detects landmarks that represent positions of eyes, a nose, and a mouth that are main features of a face. Here, the eyes, nose, and mouth are examples of the landmarks, and various elements or parts that form features of the face may be used as the landmarks. The facial image improving device 100 performs warping so that a facial image is aligned at a reference position on the basis of the landmarks to normalize rotation of the real-world facial image, which may show various rotations. For example, a rotation in a 2-dimensional roll direction among 6-axis rotations may be performed. The facial image improving device 100 resizes the size of the warped facial image to a target size to normalize the scale of the real-world facial image, which may show various scales. The facial image improving device 100 applies a facial image improving reasoner to the image normalized in rotation and scale to restore the facial image to a high-quality image. Here, the facial image improving device 100 may perform face pose estimation for showing 3D rotation information of the face, and may select a facial image improvement model optimized for each pose on the basis of the estimated face pose information. The facial image improving device 100 rotates the restored face that faces the front in an original direction or at an original angle, and inserts the result into the corresponding image. Through the above processes, the facial image may be restored more naturally.

The facial image improving device 100 detects a bounding-box for detecting a face position in an input image. The facial image improving device 100 detects landmarks that are main features of the face in the bounding-box. The facial image improving device 100 performs warping to align the facial image at a reference position on the basis of the detected landmarks.

The facial image improving device 100 resizes the warped facial image to a target size corresponding to a learned model. For example, in a case where a deep learning network (facial image improving reasoner) learned to improve an image of a size 128×128 is used, the facial image improving device 100 resizes the warped facial image to a pre-learned target size 128×128 for improvement.

The facial image improving device 100 improves the quality of the resized image. When improving the quality of the resized image, the facial image improving device 100 may perform face pose estimation, and may select a facial image improvement model optimized for each pose on the basis of the estimated face pose information.

The facial image improving device 100 inversely resizes an image having the improved quality after being aligned to the reference position and size to its original size. The facial image improving device 100 inversely warps the inversely-resized image to its original face position.

In order to smoothly operate a deep learning model in a general environment, a training environment and a test environment should be located in similar domains. Accordingly, in order to match the domains of the training environment and the test environment, the facial image improving device 100 detects a bounding-box, detects landmarks, performs warping to align the facial image at a reference position, and resizes the result to a reference scale for training data to be used in the training environment, in the same way as in the test environment.

The facial image improving device 100 shown in FIG. 1A includes an input section 110, a bounding-box detecting section 120, a landmark detecting section 130, a warping section 140, a pose estimating section 150, a parameter selecting section 152, a resizing section 160, an inference section 170, a learning section 172, an inversely-resizing section 180, an inverse warping section 190, and an output section 192. The components included in the facial image improving device 100 are not necessarily limited thereto, and all or parts of the components included in the facial image improving device 100 may be used in combination.

The respective components included in the facial image improving device 100 are connected to a communication path connecting software modules or hardware modules inside the device, and may organically cooperate with each other. These components perform communication using one or more communication buses or signal lines.

Each component of the facial image improving device 100 shown in FIG. 1A refers to a unit or section that processes at least one function or operation, and may be implemented as a software module, a hardware module, or a combination of software and hardware.

The input section 110 receives an input image. The bounding-box detecting section 120 detects a bounding-box from the input image. The landmark detecting section 130 detects landmarks that are main features of a face in the bounding-box.

The warping section 140 performs warping for aligning a facial position at a central position or a reference position on the basis of the landmarks to generate a warped facial image.

Further, the warping section 140 may fix the scale of the facial image in the bounding-box to a predetermined scale. For example, the warping section 140 may align an eye line to be positioned on a predetermined fixed line on the basis of eye feature points included in the landmarks.

As an example, in aligning the eye line to be positioned on the predetermined fixed line, in a case where it is determined that the facial image is a front facial image that faces the front, the warping section 140 may warp the facial image by rotating only the roll direction among the 6 axes of the front facial image clockwise or counterclockwise.

The warping section 140 finds feature points for the eyes, nose, and mouth of the landmarks, and extracts a midpoint of a horizontal axis line (x′) that connects the eyes. The warping section 140 extracts a midpoint of a horizontal axis line that connects both ends of the mouth. The warping section 140 connects the midpoint between the eyes and the midpoint of both ends of the mouth with a vertical axis line (y′). The warping section 140 warps the facial image on the basis of the horizontal axis line (x′) that connects the eyes and the vertical axis line (y′) that connects the midpoint between the eyes and the midpoint of both ends of the mouth.

The warping section 140 performs length correction corresponding to an aspect ratio of the face for each of the horizontal axis line (x′) that connects the eyes and the vertical axis line (y′) that connects the midpoint between the eyes and the midpoint of both ends of the mouth. The warping section 140 compares the horizontal axis line (x′) that connects the eyes with the vertical axis line (y′) that connects the midpoint between the eyes and the midpoint of both ends of the mouth in which the length correction is reflected. As a result of the comparison, the warping section 140 determines a larger axis as a reliable axis. The warping section 140 warps the facial image by performing rotation on the basis of the reliable axis.

The warping section 140 warps the facial image by rotating only the roll direction clockwise or counterclockwise when aligning the eye line in the facial image to be positioned on the predetermined fixed line.

The pose estimating section 150 may preferably be connected to the bounding-box detecting section 120, but may be connected to an output of the input section 110, the warping section 140, or the resizing section 160.

The pose estimating section 150 calculates a facial angle in a facial image of an input image, a facial image in a bounding-box, a warped facial image, or a resized warped facial image. In a case where it is determined that the facial image needs to be rotated in a yaw direction or a pitch direction among the 6 axes in order to face the front, the pose estimating section 150 determines that the facial image is a side facial image that faces a side, and performs pose estimation for the face of the facial image to estimate the facial angle.

Information estimated by the pose estimating section 150 is not limited to angles in various directions, and may be other information (information measurable from an image, such as a depth, length, height, brightness, and saturation), in which an estimated interval size, an estimated resolution, or the like of the corresponding information may be defined in various ways as necessary to estimate the information.

The parameter selecting section 152 selects a parameter corresponding to pose estimation information (for example, a facial angle).

The resizing section 160 resizes the warped facial image to a predetermined target size to generate a resized warped facial image.

The inference section 170 performs inference so as to improve the warped facial image using a pre-learned learning model to generate an improved facial image. The inference section 170 generates an improved facial image obtained by improving the resized warped facial image.

In a case where the warped facial image is a front facial image that faces the front, the inference section 170 improves the quality of the warped facial image using a restoring model learned on the basis of the front facial image. In a case where the warped facial image is a side facial image that faces a side, the inference section 170 improves the quality of the warped facial image using a restoring model learned on the basis of the side facial image.

In the facial image improving device 100, a training process and a test process are performed separately.

The learning section 172 generates a restoring model obtained by learning a result of improving the quality of the front facial image in the training process.

The learning section 172 detects a bounding-box for detecting a face position in an input image. The learning section 172 detects landmarks that are main features of the face in the bounding-box. The learning section 172 performs warping to align the face position at a reference position on the basis of the detected landmarks.

The learning section 172 resizes the warped facial image to a target size corresponding to a model to be learned. For example, in a case where a deep learning network (learning model) to be learned to improve an image to a size 128×128 is used, the facial image improving device 100 resizes the warped facial image to a learning target size 128×128.

The learning section 172 learns the resized image and an image having an improved quality of the corresponding image. In learning the resized image, in a case where the angle of the face deviates from the front, the learning section 172 estimates the angle of the face by performing pose estimation for the face. By performing classification according to the estimated facial angles (poses), it is possible to generate different inference networks for the respective angles.

The inversely-resizing section 180 generates an inversely-resized improved facial image by inversely resizing the improved facial image to its original size.

The inverse warping section 190 generate an inversely-warped facial image by inversely warping the improved facial image to the face position of the input image. The inverse warping section 190 inverts the inversely-resized improved facial image to the face position of the input image. The output section 192 applies the inversely-warped facial image to the input image and then outputs the result.

The facial image improving device 100 shown in FIG. 1B includes the input section 110, the bounding-box detecting section 120, the pose estimating section 150, the parameter selecting section 152, the resizing section 160, the inference section 170, the learning section 172, the inversely-resizing section 180, and the output section 192. The components included in the facial image improving device 100 are not necessarily limited thereto, and all or parts of the components included in the facial image improving device 100 may be used in combination.

The respective components included in the facial image improving device 100 are connected to a communication path connecting software modules or hardware modules inside the device, and may organically cooperate with each other. These components perform communication using one or more communication buses or signal lines.

Each component of the facial image improving device 100 shown in FIG. 1B refers to a unit or section that processes at least one function or operation, and may be implemented as a software module, a hardware module, or a combination of software and hardware.

The input section 110 receives an input image. The bounding-box detecting section 120 detects a bounding-box from the input image.

The pose estimating section 150 calculates, for example, a facial angle in the bounding-box.

In a case where it is determined that the facial image recognized in the bounding-box needs to be rotated in a yaw direction or a pitch direction among the 6 axes in order to face the front, the pose estimating section 150 determines that the facial image is a side facial image that faces a side, and performs pose estimation for the face of the side facial image to estimate the facial angle.

Information estimated by the pose estimating section 150 may be angles in various directions or other information (information measurable from an image, such as a depth, length, height, brightness, and saturation), in which an estimated interval size, an estimated resolution, or the like of the corresponding information may be defined in various ways as necessary to estimate the information.

The parameter selecting section 152 selects a parameter corresponding to pose estimation information (for example, a facial angle).

The resizing section 160 resizes the facial image to a predetermined target size to generate a resized facial image.

The inference section 170 performs inference so as to improve the resized facial image in the bounding-box using a learning model corresponding to the facial angle to generate an improved facial image, for example. That is, the inference section 170 generates an improved facial image obtained by improving the resized facial image.

In a case where the facial angle predicted by the pose estimating section 150 is, for example, between 0 and 30°, the inference section 170 improves the quality of the facial image using a restoring model learned with parameters corresponding to side facial images having a facial angle between 0 and 30°. In a case where the facial angle predicted by the pose estimating section 150 is, for example, between 31° and 60°, the inference section 170 improves the quality of the facial image using a restoring model learned with parameters corresponding to side facial images having a facial angle between 31° and 60°. In a case where the facial angle predicted by the pose estimating section 150 is, for example, between 61° and 90°, the inference section 170 improves the quality of the facial image using a restoring model learned with parameters corresponding to side facial images having a facial angle between 61° and 90°.

The learning section 172 may generate a learning model obtained by learning results obtained by improving various phenomena or deviations in which various face shapes change according to angles. The learning section 172 generates a restoring model obtained by learning a result of improving the quality of the deviated side facial image during the training process.

The learning section 172 generates a 0˜30° restoring model obtained by learning a result of improving the quality of a side facial image deviated between 0 and 30°, for example. The learning section 172 generates a 31˜60° restoring model obtained by learning a result of improving the quality of a side facial image deviated between 31° and 60°, for example. The learning section 172 generates a 61˜90° restoring model obtained by learning a result of improving the quality of a side facial image deviated between 61° and 90°, for example.

The inversely-resizing section 180 generates an inversely-resized improved facial image by inversely resizing the improved facial image to its original size. The output section 192 applies the inversely-resized improved facial image to the input image and then outputs the result.

FIG. 2 is a diagram illustrating a facial image improving process according to an exemplary embodiment of the invention.

As shown in (a) of FIG. 2, the facial image improving device 100 receives an input image. A face may exist in various positions in the input image.

As shown in (b) of FIG. 2, the facial image improving device 100 detects an area where the face is located in the input image. The facial image improving device 100 extracts landmarks including main features such as eyes, a nose, and a mouth in the face area. In other words, the facial image improving device 100 detects a bounding-box from the input image, and detects landmarks that are main features of the face in the bounding-box.

As shown in (c) of FIG. 2, the facial image improving device 100 performs warping for aligning the face at a central position (front facing position) or a reference position on the basis of the extracted landmarks. In other words, the facial image improving device 100 performs warping for aligning the face position at the central position or the reference position on the basis of the landmarks to generate a warped facial image. As shown in (d) of FIG. 2, the facial image improving device 100 performs inference for improving the warped facial image using a pre-learned learning model to generate an improved facial image. In other words, the facial image improving device 100 performs super-resolution (SR) for improving the image aligned at the central position (front facing position) or the reference position.

The facial image improving device 100 may use SR when improving the warped facial image. Here, the super resolution (SR) is a technique for restoring a small-sized and deteriorated low-quality image into a large-sized and high-quality image. For example, by applying the SR to an image captured by a CCTV, it is possible to improve an unclear object in an image having a small size and low quality to an object having a large size and high quality to restore the image to a level at which the object in the image can be identified. The facial image improving device 100 up-scales the warped facial image, or restores the warped facial image to a face learned using artificial intelligence.

As shown in (e) of FIG. 2, the facial image improving device 100 performs inverse warping for inverting the improved image. In other words, the facial image improving device 100 generates an inversely-warped facial image by performing inverse warping for inverting the improved facial image to the face position of the input image, and applies the inversely-warped facial image to the input image.

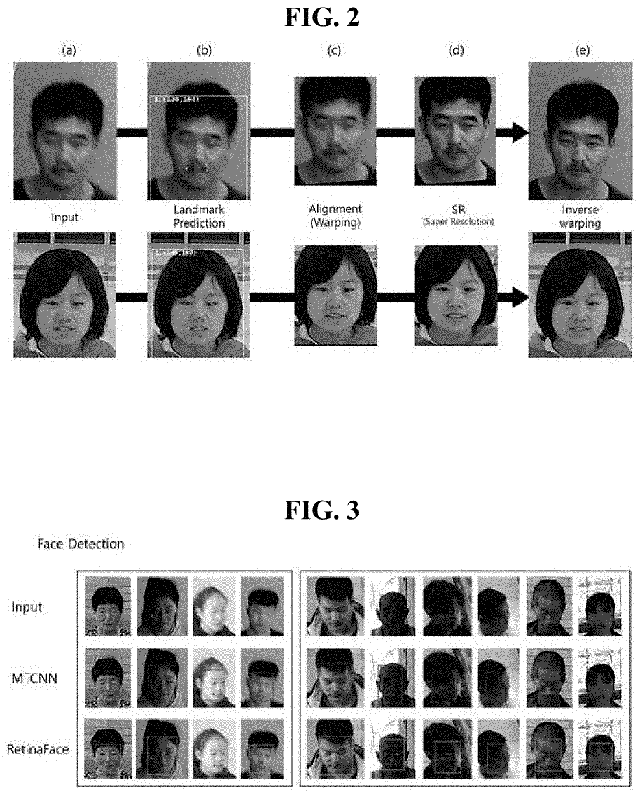

FIG. 3 is a diagram illustrating bounding-box detection and landmark position detection according to an exemplary embodiment of the invention.

The facial image improving device 100 may use a deep learning-based technique for the bounding-box detection and the landmark detection, and may preferably use deep learning having a RetinaFace structure.

The facial image improving device 100 detects a bounding-box from an input image, and detects a face in the bounding-box. The facial image improving device 100 detects landmarks from the detected face to extract main features of the face.

The facial image improving device 100 aligns the landmarks by performing face warping on the basis of the extracted landmarks to normalize face rotation. That is, the facial image improving device 100 performs rotation only in the roll direction among yaw, pitch, and roll directions.

The facial image improving device 100 resizes the aligned face size to a learned model size to normalize the face size. The facial image improving device 100 trains a model specialized for each section of yaw and pitch using face pose estimation. The facial image improving device 100 applies the above-described processes to learning and inference in the same order to improve generalization performance.

Since the training and inference are performed in the same format, the same method as that in the training is applied in the inference, so that the facial image improvement effect becomes high. That is, since the training is performed on the basis of the result obtained by detecting a bounding-box, detecting landmarks, and performing warping for aligning a face at a central position or a reference position in the same way as the testing method, it is possible to obtain a high facial image improvement effect.

During the training, in a case where learning is performed after the warping is performed to align the face at the central position or the reference position to face the front, a learning model obtained by learning results obtained by improving various phenomena and deviations in which shapes of various faces change depending on angles may be created. In this case, during the training, only results obtained by improving front-facing images are learned.

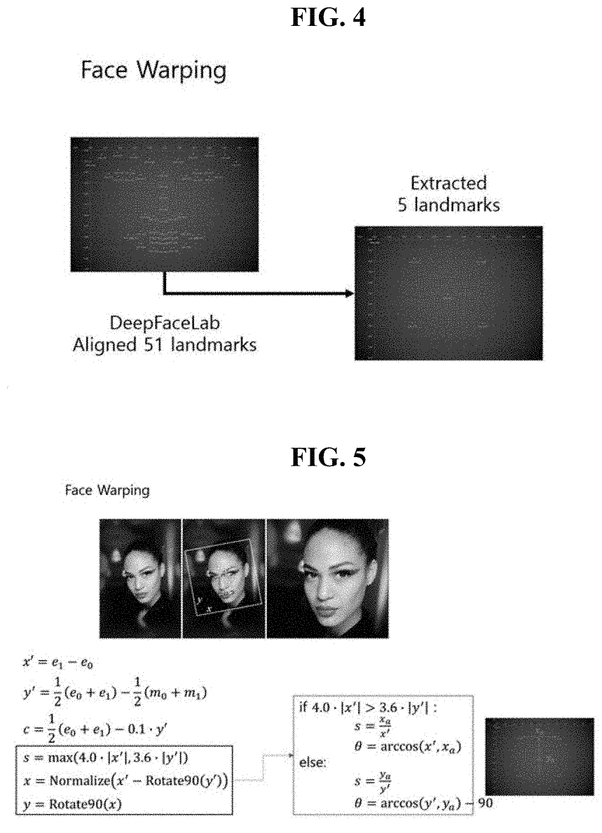

FIG. 4 is a diagram illustrating an example of a facial image warping process according to an exemplary embodiment of the invention.

As shown in FIG. 4, the facial image improving device 100 extracts, for example, 5 landmarks corresponding to a left eye, a right eye, a nose, a left end of a mouth, and a right end of the mouth from 51 landmarks that are aligned at the center of the DeepFaceLab library.

The facial image improving device 100 uses reference coordinates for aligning the 5 landmarks. The facial image improving device 100 detects the 5 landmarks from an input facial image, aligns the detected landmarks on the reference coordinates, and aligns the faces at a central position. The facial image improving device 100 acquires an input image normalized in a roll direction among rotations of 6 axes (yaw, pitch, and roll) using the above-described process.

In warping the face in the bounding-box, the facial image improving device 100 warps the face by performing rotation in the roll direction (clockwise or counterclockwise) among the 6 axes (yaw, pitch, and roll) of a 2D image. In performing warping for aligning the face at the central position or the reference position to face the front, in a case where the eye line is positioned on a constantly fixed line on the basis of the landmarks, the facial image improving device 100 performs rotation in the roll direction (clockwise or counterclockwise) to warp the face.

In warping the face in the bounding-box, in a case where it is determined that rotation is necessary in the yaw direction or pitch direction among the 6 axes of the 2D image, the facial image improving device 100 performs pose estimation for the face. The facial image improving device 100 performs the face pose estimation to predict how much the angle of the face (in the yaw direction or pitch direction) deviates from the front. In warping the face in the bounding-box, the facial image improving device 100 may perform rotation not only in the roll direction but also in the yaw direction or the pitch direction. In the training process, the facial image improving device 100 may generate each specialized restoring model obtained by learning a result of improving the face-warped image by performing rotation in the yaw direction, the pitch direction, and the roll direction.

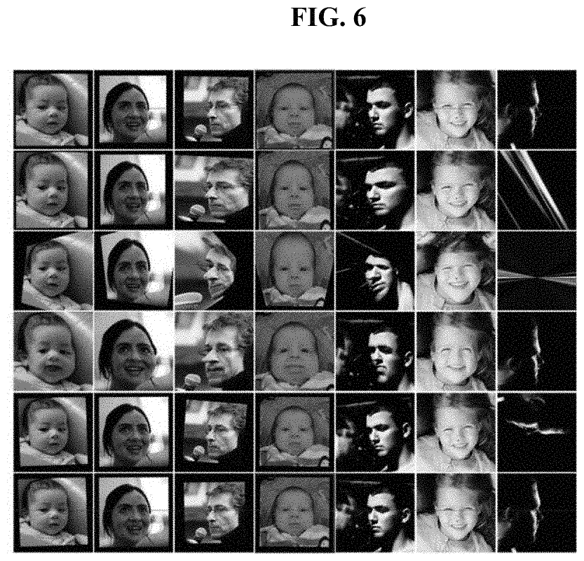

FIG. 5 is a diagram illustrating the warping process according to the exemplary embodiment in detail.

As shown in FIG. 5, the facial image improving device 100 assumes a longer line among x′ and y′ as a line that represents a face. In a case where the landmarks are incorrectly estimated or the face is excessively rotated, robust alignment may be performed.

As shown in FIG. 5, the facial image improving device 100 finds feature points for eyes, a nose, and a mouth of landmarks in order to align the face. The facial image improving device 100 connects the horizontal axis line (x′) between the eyes, and extracts a midpoint thereof. The facial image improving device 100 connects both ends of the mouth with a horizontal axis line, and extracts a midpoint thereof. The facial image improving device 100 connects the midpoint between the eyes and the midpoint of the both ends of the mouth with the vertical axis line (y′).

The facial image improving device 100 rotates the vertical axis line y′ by 90° in a counterclockwise direction. The facial image improving device 100 calculates a value obtained by adding an x-axis vector and a y-axis vector. The facial image improving device 100 may determine how much to rotate the face for alignment on the basis of the value obtained by adding the x-axis vector and the y-axis vector. Using the above-mentioned method, in a case where there is an inclination on the face, it is possible to align the face at the central position or the reference position while correcting the inclination.

In general, in a case where the horizontal axis line (x′) that connects the eyes and the vertical axis line (y′) that connects the midpoint between the eyes and the midpoint of both ends of the mouth are accurately predicted, a stable operation is obtained.

However, in general, in a case where any one of the horizontal axis line (x′) that connects the eyes and the vertical axis line (y′) that connects the midpoint between the eyes and the midpoint of both ends of the mouth is incorrectly predicted (in a case where the landmarks are incorrectly estimated), an incorrect result is obtained.

Accordingly, the facial image improving device 100 according to the present embodiment determines which axis better reflects the entire face among the horizontal axis line (x′) that connects the eyes and the vertical axis line (y′) that connects the midpoint between the eyes and the midpoint of both ends of the mouth, and uses only the better axis for alignment.

The facial image improving device 100 determines a larger axis among the horizontal axis line (x′) that connects the eyes and the vertical axis line (y′) that connects the midpoint between the eyes and the midpoint of both ends of the mouth as a more reliable axis.

For example, in a case where it is determined that the horizontal axis line (x′) that connects the eyes is shorter than the reference value, the facial image improving device 100 recognizes that the horizontal axis line (x′) that connects the eyes is an incorrectly estimated value. The facial image improving device 100 ignores the horizontal axis line (x′) that connects the eyes, and aligns the face to be positioned at the central position only on the basis of the vertical axis line (y′) that connects the midpoint between the eyes and the midpoint of both ends of the mouth.

The facial image improving device 100 first performs length correction for each of the horizontal axis line (x′) that connects the eyes and the vertical axis line (y′) that connects the midpoint between the eyes and the midpoint of both ends of the mouth. The facial image improving device 100 compares the horizontal axis line (x′) that connects the eyes and the vertical axis line (y′) that connects the midpoint between the eyes and the midpoint of both ends of the mouth in which the length correction is reflected. As a result of the comparison, the facial image improving device 100 determines a larger axis as a reliable axis. The facial image improving device 100 calculates a scale value (s) for determining how much to enlarge or reduce the face, and an angle value (0) for determining how much to rotate the face, on the basis of the reliable axis. According to the above-mentioned method, it is possible to greatly improve performance.

FIG. 6 is a diagram illustrating warping of a plurality of images according to an exemplary embodiment of the invention.

As a result of comparing a general warping method with the warping method according to the present embodiment, the facial image improving device 100 has an advantage in that the face has a uniform size regardless of the facial ratio and the eyes are located on the same line.

The facial image improving device 100 extracts landmarks including main features such as eyes, a nose, and a mouth in the face area. The facial image improving device 100 places the eye line of the face area on a fixed line on the basis of the landmarks.

The facial image improving device 100 performs warping in such a manner as to predict a transform on the basis of feature points of the landmarks. The facial image improving device 100 may use similarity transform, affine transform, perspective transform, or the like as the transform during warping.

The facial image improving device 100 may predict parameters to be converted by generating simultaneous equations for conversion on the basis of the feature points of the landmarks. The facial image improving device 100 may predict parameter values of an enlargement value, an angle value, an X-axis inclination, and a Y-axis inclination of the scale using the simultaneous equations.

As shown in FIG. 6, during warping, distortion may occur on the face, or the scale of the face may not maintain at a uniform ratio. In the case of an adult facial image, the scale may decrease during warping, and in the case of a child facial image, the scale may increase during warping. In the case of the child facial image, since a distance between the eyes and the mouth is narrow, in a case where the image is aligned at a central position, the scale increases, whereas in the case of the adult facial image, the scale decreases in the opposite manner.

Accordingly, in order to solve the above-mentioned problem, the facial image improving device 100 according to the present embodiment always places the eye line in the same area in a rectangular state and adjusts the size of the face to almost the same size. Since the size of the face is almost the same, regardless of ages, the face has almost the same ratio.

The facial image improving device 100 resizes the warped facial image to a target size (for example, 1024×1024) corresponding to the learned model. In improving the quality of the image resized to the target size, the facial image improving device 100 analyzes and improves features for all scales of the image using a multi-scale engine.

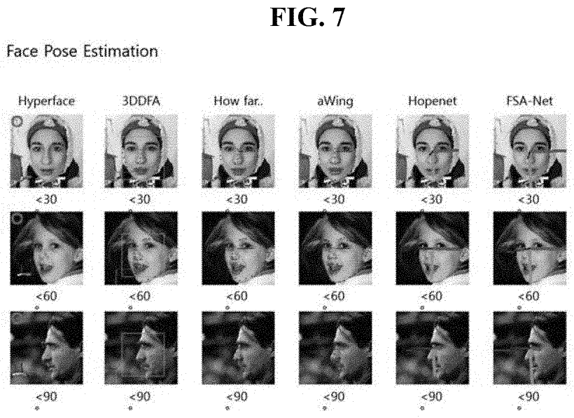

FIG. 7 is a diagram illustrating face pose estimation according to an exemplary embodiment of the invention.

The facial image improving device 100 may use a deep learning-based technique for face pose estimation, and preferably may use an FSA-Net structure.

In performing warping for aligning the face at the central position or the reference position to face the front, the facial image improving device 100 places the eye line on a constantly fixed line on the basis of the landmarks. The facial image improving device 100 also fixes the scale of the facial image in the bounding-box to a predetermined scale.

Accordingly, in a case where the face in the input image is turned to the side or the facial angle deviates from the front, considering that it is difficult to cope with such a pose change, the facial image improving device 100 additionally performs pose estimation for the face. The facial image improving device 100 performs the face pose estimation to predict how much the angle of the face deviates from the front.

In a case where the warped facial image is a front facial image that faces the front, the facial image improving device 100 improves the quality of the warped facial image (front facial image that faces the front) using a restoring model learned on the basis of the front facial image.

In a case where the warped facial image is a facial image that faces a side, the facial image improving device 100 improves the quality of the warped facial image (facial image that faces the side) using a restoring model learned on the basis of the side facial image.

In other words, in a case where the warped facial image is a facial image that faces a side, the facial image improving device 100 extracts a restoring model suitable for the angle at which the face deviates from the front. The facial image improving device 100 improves the quality of the warped facial image (the facial image that faces the side) using a restoring model suitable for the angle at which the face deviates from the front.

The facial image improving device 100 compares the warped facial image with a reference frontal image (template), and recognizes, in a case where the warped facial image differs from the reference frontal image (template) by a predetermined threshold or greater, that the warped facial image is a side facial image. In a case where the warped facial image is recognized as the side facial image, the facial image improving device 100 performs pose estimation for the face to predict a deviated angle of the face.

The facial image improving device 100, for example, generates a 0˜30° restoring model by learning a result of improving the quality of a side facial image deviated at an angle between 0 and 30° in the training process. In a case where the warped image is determined as the side facial image, and in a case where the deviated facial angle is determined between 0 and 30° as a result of the pose estimation, the facial image improving device 100 improves the quality of the warped image using the 0˜30° restoring model.

The facial image improving device 100, for example, generates a 31˜60° restoring model learned from a result of improving the quality of a side facial image deviated at an angle between 31° and 60° in the training process. In a case where the warped image is determined as the side facial image, and in a case where the deviated facial angle is determined between 31° and 60° as a result of the pose estimation, the facial image improving device 100 improves the quality of the warped image using the 31˜60° restoring model.

The facial image improving device 100, for example, generates a 61˜90° restoring model learned from a result of improving the quality of a side facial image deviated at an angle between 61° and 90° in the training process. In a case where the warped image is determined as the side facial image, and in a case where the deviated facial angle is determined between 61° and 90° as a result of the pose estimation, the facial image improving device 100 improves the quality of the warped image using the 61˜90° restoring model.

The above description is merely an example of the technical idea of the present inventive concept, and various modifications and variations can be made to those skilled in the art without departing from the concept of the present inventive concept. Accordingly, the above-described embodiments are not intended to limit the technical idea of the present inventive concept, and the scope of the technical idea of the present inventive concept is not limited by the embodiments. The scope of protection of the present inventive concept should be interpreted according to claims and all technical ideas equivalent thereto should be interpreted as being included in the scope of the invention.

1. A device for improving a facial image comprising:
a bounding-box detecting section that detects a bounding-box from an input image;
a landmark detecting section that detects landmarks that are main features of a face in the bounding-box;
a warping section that performs warping for aligning a face position at a central position or a reference position on the basis of the landmarks to generate a warped facial image;
an inference section that performs inference so as to improve the warped facial image using a pre-learned leaning model to generate an improved facial image;
an inverse warping section that performs inverse warping for inverting the improved facial image to the face position of the input image to generate an inversely-warped facial image; and
an output section that applies the inversely-warped facial image to the input image.

2. The device according to claim 1, further comprising:
a resizing section that resizes the warped facial image to a preset target size to generate the resized warped facial image; and
an inversely-resizing section that inversely resizes the improved facial image generated by improving the resized warped facial image in the inference section to an original size to generate an inversely-resized improved facial image,
wherein the inversely-resized improved facial image is inverted to the facial position of the input image by the inverse warping section.

3. The device according to claim 1,
wherein the warping section aligns an eye line to be positioned on a predetermined fixed line on the basis of feature points of eyes included in the landmarks, with respect to the facial image in the bounding-box.

4. The device according to claim 3,
wherein in aligning the eye line to be positioned on the predetermined fixed line, in a case where it is determined that the facial image is a front facial image that faces the front, the warping section warps the facial image by rotating the front facial image in a forward direction or a roll direction among 6 axes.

5. The device according to claim 3,
wherein in aligning the eye line to be positioned on the predetermined fixed line, the warping section warps the facial image by rotating the front facial image clockwise or counterclockwise only in the roll direction.

6. The device according to claim 1,
wherein the warping section finds feature points for the eyes, nose, and mouth of the landmarks, extracts a midpoint of a horizontal axis (x′) that connects the eyes, extracts a midpoint of a horizontal axis line that connects both ends of the mouth, connects the midpoint between the eyes and the midpoint of both ends of the mouth as a vertical axis line (y′), and warps the facial image on the basis of the horizontal axis line (x′) that connects the eyes and the vertical axis line (y′) that connects the midpoint between the eyes and the midpoint of both ends of the mouth.

7. The device according to claim 6,
wherein the warping section performs length correction corresponding to an aspect ratio of the face for each of the horizontal axis line (x′) that connects the eyes and the vertical axis line (y′) that connects the midpoint between the eyes and the midpoint of both ends of the mouth, compares the horizontal axis line (x′) that connects the eyes with the vertical axis line (y′) that connects the midpoint between the eyes and the midpoint of both ends of the mouth in which the length correction is reflected, determines a larger axis as a reliable axis as a result of the comparison, and warps the facial image by performing rotation on the basis of the reliable axis.

8. The device according to claim 1,
wherein the inference section improves, in a case where the warped facial image is a front facial image that faces the front, the quality of the warped facial image using a restoring model learned on the basis of the front facial image.

9. The device according to claim 8, further comprising:
a pose estimating section determines, in a case where it is determined that the warped facial image needs to be rotated in a yaw direction or a pitch direction among the 6 axes in order to face the front, that the facial image is a side facial image that faces a side, and performs pose estimation for the face of the side facial image to estimate a facial angle; and
a parameter selecting section that selects a parameter corresponding to the facial angle.

10. The device according to claim 1,
wherein the inference section improves, in a case where the warped facial image is a side facial image that faces a side, the quality of the warped facial image using a restoring model learned on the basis of the side facial image.

11. A facial image improving method comprising:
detecting a bounding-box from an input image;
detecting landmarks that are main features of a face in the bounding-box;
performing warping for aligning a face position at a central position or a reference position on the basis of the landmarks to generate a warped facial image;
performing inference so as to improve the warped facial image using a pre-learned leaning model to generate an improved facial image;
performing inverse warping for inverting the improved facial image to the face position of the input image to generate an inversely-warped facial image; and
applying the inversely-warped facial image to the input image.

12. A device for improving a facial image, comprising:
a bounding-box detecting section that detects a bounding-box from an input image;
a pose estimating section that calculates a facial angle in the bounding-box;
a parameter selecting section that selects a parameter corresponding to the facial angle; and
an inference section that performs inference so as to improve the facial image using a pre-learned leaning model to generate an improved facial image.

13. The device according to claim 12,
wherein the inference section selects a parameter corresponding to an angular range including the estimated facial angle in response to a plurality of angular ranges that are defined in advance by the parameter selecting section, using the facial angle predicted by the pose estimating section, and applies information on the selected parameter to improve the quality of the facial image.

14. A method for improving a facial image, comprising:
detecting a bounding-box from an input image;
calculating a facial angle in the bounding-box;
selecting a parameter corresponding to the facial angle; and
performing inference so as to improve the facial image in the bounding-box using a learning model corresponding to the parameter to generate an improved facial image.
